(19) United States
(12) Patent Application Publication
(10) Pub. No.: US 2011/0259551 A1
(43) Pub. Date: Oct. 27, 2011

(54) FLOW DISTRIBUTOR AND ENVIRONMENTAL CONTROL SYSTEM PROVIDED THE SAME

(76) Inventors: Kazushige Kasai, Minnetonka, MN (US); Takaya Ishiguro, St. Louis Park, MN (US)

(21) Appl. No.: 12/766,025

(22) Filed: Apr. 23, 2010

(51) Int. Cl. F28F 27/02; F16K 11/10

(52) U.S. Cl. 165/100; 137/597

(57) ABSTRACT

A flow distributor is adapted to distribute two-phase refrigerant into a plurality of flow paths. The flow distributor includes a tubular main body having a center axis, at least one inlet port, and a plurality of outlet ports. The inlet port is disposed in a lower portion of the main body in a state in which the center axis of the main body is oriented in a generally vertical direction. The inlet port has a center axis that is not parallel to and does not intersect with the center axis of the main body so as to generate an upward spiraling flow of the refrigerant within the main body. The outlet ports form a plurality of openings disposed in an upper portion of the main body in the state in which the center axis of the main body is oriented in the generally vertical direction, with all of the openings being at least partially arranged in a plane orthogonal to the center axis of the main body.

### BACKGROUND

1. Field of the Invention

The present invention generally relates to a flow distributor and an environmental control system provided with the flow distributor. More specifically, the present invention relates to a flow distributor used in an environmental control system to distribute two-phase refrigerant into a plurality of flow paths.

2. Background Information

In conventional environmental control systems such as air-conditioning systems, chillers, heat-pump systems, refrigerators, and the like utilizing a two-phase refrigerant that undergoes a phase change from gas to liquid, or vice versa, a refrigerant flow path is often divided into a plurality of passages by a flow distributor or divider at an upstream portion of an evaporator and/or within the evaporator in order to prevent performance degradation of the evaporator due to two-phase flow pressure drop.

FIGS. 15A to 15D are schematic views of examples of conventional flow distributors. FIG. 15A shows a T-shaped flow divider in which two pipes are simply connected together to form a T-shape. The T-shaped flow divider has advantage of low manufacturing cost. However, when distribution of the liquid component in two-phase refrigerant at the inlet portion of the flow divider is not uniform as shown in FIG. 15A, the refrigerant is discharged from the outlet ports while the liquid component of the refrigerant is unevenly distributed between the outlet ports. Such an uneven distribution of the liquid component at the inlet portion of the flow divider as shown in FIG. 15A may be caused by many reasons such as influence of gravity due to an installation angle of the divider, production errors (e.g., asymmetrical structure of the divider, variation in surface wettability), and variation in flow condition of the liquid component in the refrigerant at the inlet port due to bending, merging and/or diverging of an upstream pipe. In the example shown in FIG. 15A, the refrigerant discharged from the outlet port on the right side contains more liquid component than the refrigerant discharged from the outlet port on the left side. In other words, the void fraction of the refrigerant discharged from the outlet port on the right side is different from the void fraction of the refrigerant discharged from the outlet port on the left side. Such an uneven distribution of the liquid component in the refrigerant may cause performance degradation in the evaporator which is disposed in a downstream portion of the flow divider.

FIG. 15B shows a trunk-type divider in which the two-phase refrigerant is first introduced into a hallow cylinder so that liquid component and vapor component of the two-phase refrigerant are mixed in the cylinder. Then, the refrigerant is discharged from the outlet ports, each of which has a relatively small diameter to increase friction resistance in order to distribute the refrigerant evenly. However, with the trunk-type divider, when the liquid component of the refrigerant is not symmetrically distributed in the cylinder as shown in FIG. 15B, the flow of the refrigerant may be drifted toward one side to cause uneven distribution of the liquid component among the outlet ports.

FIG. 15C shows an internally-branched-type flow divider in which the refrigerant path is internally divided into a plurality of outlet ports by providing structural elements, such as a narrow channel structure and/or a protruding structure, within the divider in order to evenly distribute the refrigerant. However, providing such internal structures in the divider requires precise manufacturing process, which may result in high manufacturing cost. Moreover, the narrow channel structure and/or the protruding structure may cause an increase in pressure loss within the divider.

FIG. 15D shows a header-type divider in which a plurality of outlet ports is provided on a side wall of a cylindrical header (manifold). With this type of flow divider, when the pressure and the flow amount are not uniform within the header, the refrigerant tends to be drifted toward one side, which causes uneven distribution of the liquid component of the refrigerant among the outlet ports.

The refrigerant circuit of an air-conditioning system may be provided with a plurality of flow dividers, such as one type of the conventional flow dividers as described above, so that each of the outlet ports of the flow divider is connected to another flow divider to further divide the refrigerant flow exiting from the outlet port. By providing a plurality of flow dividers in the system, the refrigerant flow can be divided into a larger number of flow paths, which may be necessary for larger industrial systems. However, since the refrigerant flow needs to pass through multiple flow dividers, unevenness in distribution of the liquid component in the refrigerant in the upstream flow divider tend to be cumulatively propagated in the downstream flow dividers.

Furthermore, in larger industrial environmental control systems, each of main components (e.g., a compressor, a heat exchanger and the like) can be formed by combining a plurality of regular size components to collectively increase the capacity, instead of increasing size of a single component, because such an approach is more economical. A refrigerant circuit in such a larger size system may require merging and/or diverging of conduits in order to connect the individual components. However, such merging and/or diverging of conduits may further promote uneven distribution of the liquid component of the refrigerant in the flow dividers when the conventional flow dividers as described above are used. Moreover, a larger size system usually requires a large amount of refrigerant to be circulated, and thus, diameters of the refrigerant pipes are relatively large. Thus, the flow condition of the liquid component of the refrigerant within the pipes is more prone to be disturbed by influence of gravity.

On the other hand, U.S. Patent Application Publication No. 2008/0000263 proposes another type of flow distributor in which the two-phase refrigerant introduced into a cylindrical vessel at an upper position of the cylinder generates a downward spiraling flow and exits from outlet ports formed in a lower portion of the cylindrical vessel. In this flow distributor, the two-phase refrigerant flows from the inlet pipe into the cylindrical vessel from a tangential direction, and the refrigerant separates into gas and liquid by the centrifugal force acting on the refrigerant in the process of swirling inside the cylindrical vessel. The heavier liquid collects at the peripheral side while the lighter gas collects at the center. The gas then flows from an outlet to the distribution pipes in the process of moving while swirling.

### SUMMARY

Generally, the volume fraction of the liquid component in the two-phase refrigerant flowing into an inlet portion of the evaporator is relatively small, and thus, the refrigerant contains less liquid. However, with the flow distributor disclosed in U.S. Patent Application Publication No. 2008/0000263, since the refrigerant flow is directed downwardly within the cylindrical vessel, the lighter vapor component has to push the heavier liquid component aside in order to exit the cylindrical vessel. Such disturbance within the cylindrical vessel may cause distribution of the liquid component that has been collected along an inner wall of the cylindrical vessel to become non-uniform, which results in uneven distribution of the liquid component among the outlet ports. Since the liquid component in the refrigerant plays a major role in heat exchanging process conducted in the evaporator, it is important that the distributor provided in an upstream portion of the evaporator is arranged to evenly distribute the liquid component of the two-phase refrigerant into a plurality of flow passages in the evaporator in order to improve efficiency and performance of the evaporator (e.g., evaporation temperature, evaporation performance, refrigerant flow rate, heat transmission coefficient, etc.)

In view of the problems in the conventional flow distributors as described above, one object is to provide a flow distributor that can evenly distribute the liquid component of the two-phase refrigerant with high efficiency at low cost.

A flow distributor according to one aspect is adapted to distribute two-phase refrigerant into a plurality of flow paths. The flow distributor includes a tubular main body, at least one inlet port, and a plurality of outlet ports. The tubular main body has a center axis. The inlet port is disposed in a lower portion of the main body in a state in which the center axis of the main body is oriented in a generally vertical direction. The inlet port has a center axis that is not parallel to and does not intersect with the center axis of the main body so as to generate an upward spiraling flow of the refrigerant within the main body. The outlet ports form a plurality of openings disposed in an upper portion of the main body in the state in which the center axis of the main body is oriented in the generally vertical direction, with all of the openings being at least partially arranged in a plane orthogonal to the center axis of the main body.

An environmental control system according to another aspect includes first and second heat exchanging parts, and a flow distributing mechanism. The flow distributing mechanism is disposed in a refrigerant path between the first and second heat exchanging parts to distribute two-phase refrigerant flowing in at least one upstream pipe of the refrigerant path connected from the first heat exchanging part into a plurality of downstream pipes of the refrigerant path connected to the second heat exchanging part. The flow distributing mechanism includes a flow distributor. The flow distributor has a tubular main body, at least one inlet port, and a plurality of outlet ports. The tubular main body has a center axis oriented in a generally vertical direction. The inlet port communicates with the upstream pipe. The inlet port is disposed in a lower portion of the main body and having a center axis that is not parallel to and does not intersect with the center axis of the main body so as to generate an upward spiraling flow of the refrigerant within the main body. The outlet ports communicate with the downstream pipes, the outlet ports forming a plurality of openings disposed in an upper portion of the main body with all of the openings being at least partially arranged in a plane orthogonal to the center axis of the main body.

### BRIEF DESCRIPTION OF THE DRAWINGS

Referring now to the attached drawings which form a part of this original disclosure:

FIG. 1 is a simplified schematic diagram of a heat pump system provided with a flow distributor according to an embodiment of the present invention;

FIG. 2 is a simplified elevational view of a flow distributing mechanism installed in the heat pump system according to the embodiment;

FIG. 3 is a top perspective view of a flow distributor of the flow distributing mechanism shown in FIG. 2 according to the embodiment;

FIG. 4 is a bottom perspective view of the flow distributor according to the embodiment;

FIG. 5 is a top plan view of the flow distributor according to the embodiment;

FIG. 6 is an enlarged view of an inlet port of the flow distributor according to the embodiment;

FIG. 7 is an enlarged view of an outlet port of the flow distributor according the embodiment;

FIG. 8 is a cross-sectional view of the flow distributor according to the embodiment as taken along a section line 8-8 in FIG. 3;

FIG. 9 is a cross-sectional view of the flow distributor according to the embodiment as taken along a section line 9-9 in FIG. 8;

FIG. 10 is a cross-sectional view of the flow distributor schematically illustrating an upward spiralling flow of two-phase refrigerant generated within a main body of the flow distributor according to the embodiment;

FIG. 11 is a cross sectional view of a flow distributor showing an example of an asymmetric arrangement of outlet ports according a modified embodiment;

FIG. 12 is a cross sectional view of a flow distributor showing an example of an asymmetric arrangement of inlet ports according to a modified embodiment;

FIG. 13 is a perspective view of a flow distributor showing an example in which outlet ports are disposed on a top wall of a tubular main body according to a modified embodiment;

FIGS. 14A to 14D are cross sectional views of examples of an arrangement of upstream pipes connected to the flow distributor; and

FIGS. 15A to 15D are schematic views of examples of conventional flow distributors.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

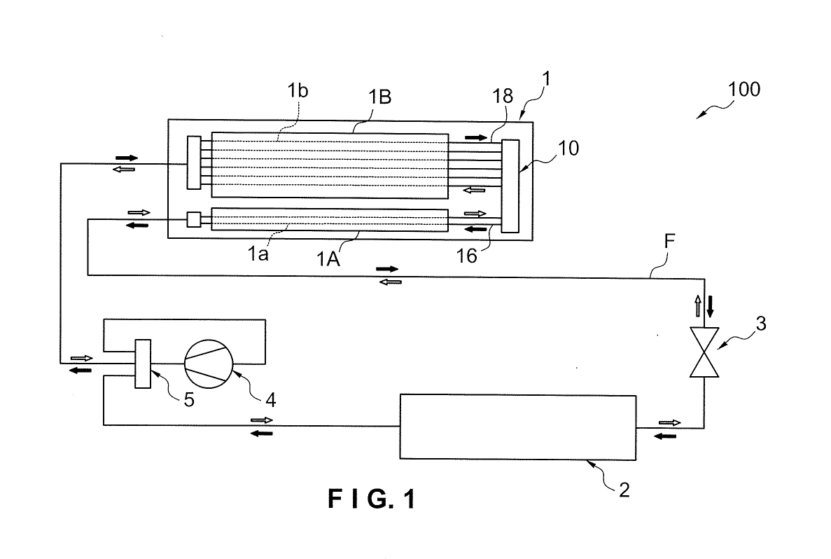

Referring initially to FIG. 1, a heat pump system 100 as one example of an environmental control system (ECS) is illustrated in accordance with an embodiment of the present invention. The heat pump system 100 of the embodiment is a reversible-cycle heat pump refrigeration system including a first heat exchanger 1, a second heat exchanger 2, an expansion valve 3, a compressor 4 and a 4-way reversing valve 5, that are disposed in a refrigerant circuit F formed by conduits. During operation of the heat pump system 100, the refrigerant undergoes a phase change in which it changes from liquid to gas (vapor), or vice versa, depending on whether the heat pump system 100 is in heating mode or cooling mode. The first heat exchanger 1, the second heat exchanger 2, the expansion valve 3, the compressor 4 and the 4-way reversing valve 5 are conventional components that are well known in the art, except that the first heat exchanger 1 is provided with a flow distributing mechanism 10 according to the present embodiment as describe in more detail below. Since these components are well known in the art, these structures will not be discussed or illustrated in detail herein. Rather, it will be apparent to those skilled in the art from this disclosure that the components can be any type of structure that can be used to carry out the present invention.

The first and second heat exchangers 1 and 2 are designed to function interchangeably as an evaporator and a condenser. The first and second heat exchangers 1 and 2 operate to heat or cool the air (e.g. building interior) or substance (e.g. industrial liquids, swimming pool, fish tank, etc.) to be conditioned. In “cooling mode,” the first heat exchanger 1 functions as the condenser while the second heat exchanger 2 functions as the evaporator. In “heating mode,” the roles are reversed, that is, the first heat exchanger 1 functions as the evaporator while the second heat exchanger 2 functions as the condenser. The compressor 4 is configured and arranged to pump the refrigerant through the refrigerant circuit F at a high pressure. The 4-way reversing valve 5 is configured and arranged to control the direction of refrigerant pumped from the compressor 4 in the refrigerant circuit F to switch between heating mode and cooling mode. In FIG. 1, the direction of the refrigerant flow during operation of the heat pump system 100 in heating mode is shown by white arrows and the direction of the refrigerant flow during operation of the heat pump system 100 in cooling mode is shown by black arrows.

In heating mode, the first heat exchanger 1 functions as the evaporator while the second heat exchanger 2 functions as the condenser, as discussed above. The 4-way reversing valve 5 diverts the high pressure refrigerant gas to a conduit leading to the second heat exchanger 2. Heat from the refrigerant gas is released into the conditioned area or substance (e.g. industrial liquids, water, or indoor air), resulting in condensation of the high pressure refrigerant gas into a high pressure liquid. The refrigerant liquid exits the second heat exchanger 2 and travels through the conduit, and then enters the first heat exchanger 1, which functions as the evaporator in heating mode. Here, heat is absorbed from outside the system and into the first heat exchanger 1, thereby vaporizing the refrigerant liquid contained therein into a low pressure gas. The refrigerant gas then exits the first heat exchanger 1 through a conduit and is diverted to the compressor 4 via the 4-way reversing valve 5.

In cooling mode, the 4-way reversing valve 5 diverts the high pressure refrigerant gas exiting the compressor 4 via the conduit leading to the first heat exchanger 1, which in cooling mode functions as the condenser. The resulting condensed high pressure liquid exits the first heat exchanger 1 and enters the second heat exchanger 2, which functions as the evaporator. Heat is absorbed from the conditioned area or substance (e.g. industrial liquid, water, or indoor air), resulting in vaporization of the refrigerant liquid into gas. The low pressure refrigerant gas exits the second heat exchanger 2 and returns to the compressor 4.

While the path of the refrigerant between the first and second heat exchangers 1 and 2 may be reversed, the direction of refrigerant flow to and from the compressor 4 is always the same, regardless of the operation mode.

The first heat exchanger 1 includes a first heat exchanging part 1A, a second heat exchanging part 1B, and the flow distributing mechanism 10 disposed between the first heat exchanging part 1A and the second heat exchanging part 1B. The first heat exchanging part 1A and the second heat exchanging part 1B are arranged so that a number of internal passage(s) 1a (e.g., coils) within the first heat exchanging part 1A is smaller than a number of internal passages 1b (e.g., coils) within the second heat exchanging part 1B. Although only two lines are shown as the internal passages 1a and only six lines are shown as the internal passages 1b in the schematic diagram of FIG. 1, the actual numbers of the internal passages 1a and 1b are determined based on the specification of the first heat exchanger 1.

The flow distributing mechanism 10 is connected to the first heat exchanging part 1A of the first heat exchanger 1 via one or more pipes 16, and connected to the second heat exchanging part 1B via a plurality of pipes 18 corresponding to the number of the internal passages 1b. Although two lines are shown as the pipes 16 in the schematic diagram of FIG. 1, the actual number of the pipes 16 varies depending on the actual number of the internal passages 1a and also depending on the design specification, piping arrangement, and space limitation imposed on the flow distributing mechanism 10. For example, the pipes 16 may be provided by the same number as the number of the internal passages 1a in the first heat exchanging part 1A, by a smaller number than the number of the internal passages 1a in the first heat exchanging part 1A or by a larger number than the number of the internal passages 1a in the first heat exchanging part 1A. When the number of the pipes 16 is different from the number of the internal passages 1a of the first heat exchanging part 1A, a connection pipe portion or portions are appropriately provided between the internal passages 1a and the pipes 16 to divide or merge the refrigerant flow therebetween.

Accordingly, when the heat pump system 100 operates in heating mode, the refrigerant flowing out of the first heat exchanging part 1A enters into the flow distributing mechanism 10 via the pipes 16. The refrigerant is divided into a plurality of flow paths corresponding to the number of the pipes 18 by the flow distributing mechanism 10, and then the refrigerant enters the second heat exchanging part 1B via the pipes 18. When the heat pump system 100 operates in cooling mode, the refrigerant flowing from the second heat exchanging part 1B to the flow distributing mechanism 10 via the pipes 18 is merged and distributed into the pipes 16, and then the refrigerant enters the internal passages 1a of the first heat exchanging part 1A.

As described above, when the heat pump system 100 operates in heating mode, the first heat exchanger 1 functions as the evaporator that vaporizes the refrigerant liquid contained therein into a low pressure gas. More specifically, the refrigerant first enters the first heat exchanging part 1A and part of the refrigerant liquid is vaporized into gas while the refrigerant passes through the internal passages 1a of the first heat exchanging part 1A. Thus, a dryness fraction of the refrigerant at an inlet portion of the first heat exchanging part 1A is smaller than a dryness fraction of the refrigerant at an inlet portion of the second heat exchanging part 1B. More specifically, the refrigerant flowing out of the first heat exchanging part 1A generally has a relatively low dryness fraction or quality and a relatively high void fraction. In other words, the two-phase refrigerant exiting the first heat exchanging part 1A has a relatively low volume fraction (percentage) of liquid component, which is usually about 10% to about 30% when the refrigerant is HFC refrigerant such as R134a, R410A, and the like and when the dryness fraction is about 0.2 to about 0.3, although the actual volume fraction of liquid component varies depending on other factors such as the refrigerant flow condition, refrigerant temperature, refrigerant pressure, etc. However, the liquid component of the refrigerant plays a major role in heat exchanging process in the first heat exchanger 1 which functions as the evaporator during heating mode. Thus, it is desirable to distribute the liquid component in the refrigerant exiting the first heat exchanging part 1A into the internal passages 1b (coils) of the second heat exchanging part 1B as evenly as possible so that the liquid component of the refrigerant is efficiently vaporized as it passes through the internal passages 1b (coils) of the second heat exchanging part 1B. Therefore, the flow distributing mechanism 10 is configured and arranged to substantially evenly distribute the liquid component of the two-phase refrigerant flow exiting from the first heat exchanging part 1A into a plurality of flow paths corresponding to the internal passages 1b of the second heat exchanging part 1B so that the volume fraction of the liquid component in the refrigerant that passes through each of the internal passages 1b of the second heat exchanging part 1B is generally uniform.

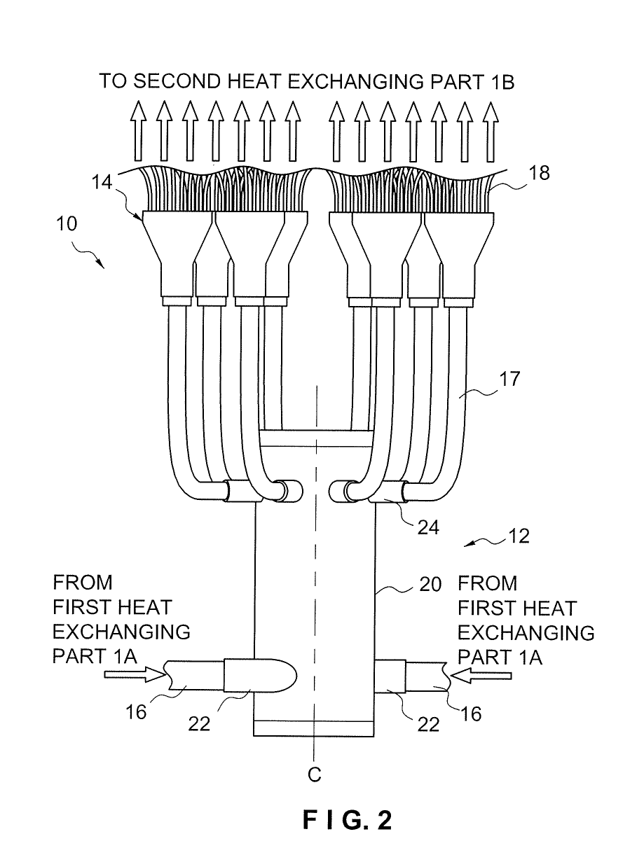

Referring to FIG. 2, the flow distributing mechanism 10 will now be explained in more detail according to the embodiment. As used herein to describe the flow distributing mechanism 10 of the present embodiment, the terms “upstream”, “downstream”, “inlet”, and “outlet” are used with respect to the direction of refrigerant flow when the heat pump system 100 operates in heating mode (i.e., the direction of refrigerant flow shown by the white arrows in FIG. 1) during which the first heat exchanger 1 functions as the evaporator. Accordingly, these terms, as utilized to describe the flow distributing mechanism 10 of the present embodiment should be interpreted relative to the direction of refrigerant flow when the heat exchanger 1 functions as the evaporator in heating mode.

As shown in FIG. 2, the flow distributing mechanism 10 includes a flow distributor 12 and a plurality of secondary flow distributors 14. The flow distributor 12 is disposed on the upstream side in the flow distributing mechanism 10 and connected to the upstream pipes 16 that are communicated with the internal passages 1a in the first heat exchanging part 1A of the first heat exchanger 1. In this embodiment, the refrigerant enters into the flow distributor 12 from two locations via the upstream pipes 16. The secondary flow distributors 14 are disposed on the downstream side in the flow distributing mechanism 10 and connected to the downstream pipes 18 that are respectively communicated with the internal passages 1b formed in the second heat exchanging part 1B of the first heat exchanger 1. The flow distributor 12 and the secondary flow distributors 14 are connected via a plurality of connection pipes 17 as shown in FIG. 2.

The flow distributor 12 is configured and arranged to evenly distribute the two-phase refrigerant flowing from the first heat exchanging part 1A of the first heat exchanger 1 via the upstream pipes 16 into the connection pipes 17 by generating an upward spiraling flow (cyclonic flow) of the two-phase refrigerant within the flow distributor 12. Then, each of the secondary flow distributors 14 further divides the two-phase refrigerant flowing from the flow distributor 12 through the corresponding connection pipe 17 into the downstream pipes 18 so that the refrigerant flows into the internal passages 1b of the second heat exchanging part 1B of the first heat exchanger 1.

In the illustrated embodiment, eight secondary flow distributors 14 are provided in the flow distributing mechanism 10. Of course, it will be apparent to those skilled in the art from this disclosure that the number and arrangement of the secondary flow distributors 14 are not limited to the arrangement illustrated in this embodiment, and they can be determined according to various considerations (e.g., number of the connection pipes 17, number of the internal passages 1b in the second heat exchanging part 1B, space limitation imposed on the flow distributing mechanism 10, etc.). Moreover, the secondary flow distributors 14 may be entirely omitted if the number of the downstream pipes 18 is relatively small. In such a case, the flow distributor 12 can be directly connected to the downstream pipes 18.

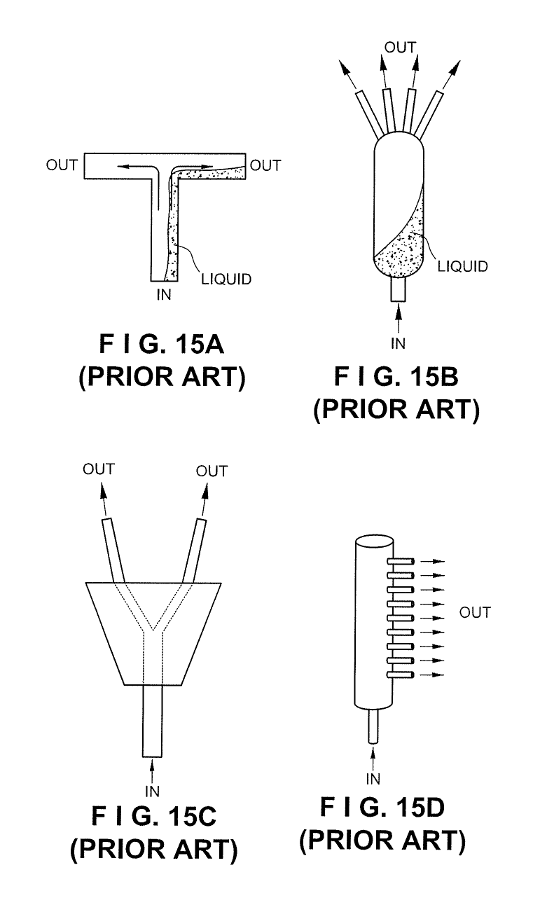

In this embodiment, each of the secondary flow distributors 14 preferably includes a conventional structure such as the internally-branched-type flow divider shown in FIG. 15C. Alternatively, other types of conventional flow distributors (e.g., the T-shaped divider shown in FIG. 15A, the trunk type divider shown in FIG. 15B, the header-type divider shown in FIG. 15D, etc.) can be used as the secondary flow distributors 14. Further alternatively, a plurality of flow distributors each having the similar structure as the flow distributor 12 as described below may be used as the secondary flow distributors 14 instead of the conventional flow dividers.

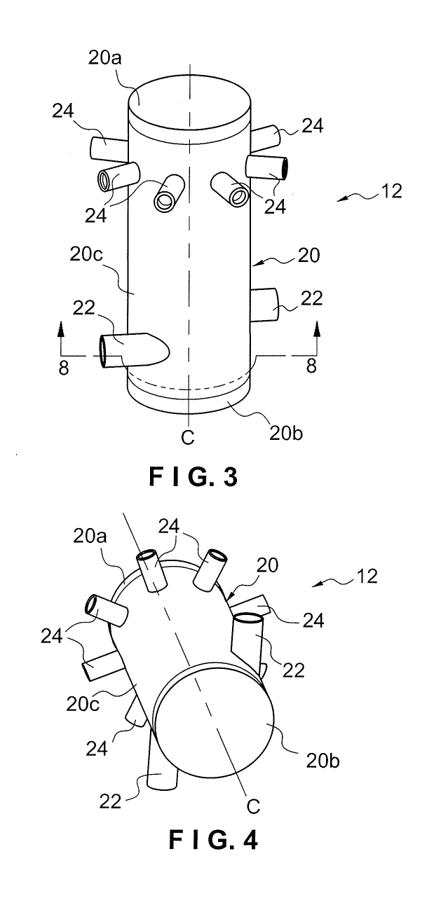

Referring now to FIGS. 3 to 10, the structure and operation of the flow distributor 12 will be described in more detail. As seen in FIGS. 3 and 4, the flow distributor 12 includes a tubular main body 20 having a center axis C, two inlet ports 22, and a plurality of outlet ports 24. The main body 20, the inlet ports 22 and the outlet ports 24 are preferably made of metal or composition metal (e.g., iron, brass, copper, aluminum, stainless steel and the like) and formed as a unitary member. When the flow distributor 12 is installed in the heat pump system 100, the flow distributor 12 is preferably disposed so that the center axis C of the main body 20 is oriented in the generally vertical direction as shown in FIG. 2. As used herein, the phrase “the center axis C is oriented in the generally vertical direction” refers to when an inclination angle of the center axis C with respect to the vertical direction is in a range between −2° and +2°. Also as used herein to describe the flow distributor 12 of the present embodiment, the following directional terms “up”, “down”, “upper”, “lower”, “top”, “bottom”, “side”, “lateral”, and “transverse”, as well as any other similar directional terms refer to those directions in a state in which the flow distributor 12 is disposed so that the center axis C of the main body 20 is oriented in the generally vertical direction as shown in FIG. 2. Accordingly, these directional terms, as utilized to describe the flow distributor 12 of the present embodiment, should be interpreted relative to the flow distributor 12 in a state in which the center axis C of the main body 20 is oriented in the generally vertical direction as shown in FIG. 2.

As shown in FIGS. 3, 4 and 9, the main body 20 of the flow distributor 12 is a generally enclosed, hallow cylindrical member having an upper cover plate 20a defining an upper end wall, a lower cover plate 20b defining a bottom end wall and a cylindrical part 20c defining a side wall.

The dimension of the flow distributor 12 is determined so that an upward spiraling flow (cyclonic flow) is reliably and steadily generated within the main body 20 of the flow distributor 12. More specifically, the dimension of the flow distributor 12 is preferably determined based on various considerations including the specification of the first heat exchanger 1 (e.g., size, capacity, refrigerant circulation rate, refrigerant flow rate etc.), the type of the refrigerant used, the number and size of the upstream conduits connected to the flow distributor 12, the number and size of the downstream conduits connected to the flow distributor 12, and the like. In general, the flow distributor 12 is preferably designed to satisfy the following relationship.

2<D1/Di<10,

No×Do<π×D2, and

2×D1<H<5×D1.

In the above equations, a value D1 represents an inner diameter of the main body 20 of the flow distributor 12, a value D2 represents an outer diameter of the main body 20, a value Di represents an outer diameter of the upstream conduit connected to the flow distributor (in this embodiment, the outer diameter of the upstream pipe 16), a value No represents the number of the downstream conduits connected to the flow distributer 12 (in this embodiment, the number of the connection pipes 17), a value Do represents an outer diameter of the downstream conduit connected to the flow distributer 12 (in this embodiment, the outer diameter of the connection pipe 17), and a value H represents an inner height of the main body 20 (see, FIG. 9). For example, when the heat pump system 100 is a relatively large industrial air-cooled chiller using R134a as the refrigerant and when the outer diameter Di of the upstream pipe 16 is ¾ inch, the outer diameter Do of the connection pipe 17 is ⅜ inch and eight connection pipes 17 are provided, the inner diameter D1 of the main body 20 is preferably about 3.5 inches, the outer diameter D2 of the main body 20 is preferably about 4 inches and the inner height H of the main body 20 is preferably about 9 inches. A thickness of the upper cover plate 20a is determined so that the upper cover plate 20a withstands lift force generated by the refrigerant flow inside the main body 20. Of course, it will be apparent to those skilled in the art from this disclosure that when the flow distributor 12 is adapted to be used in a smaller environmental control system such as a residential air-conditioning apparatus, a refrigerator, or the like, an overall size of the flow distributor 12 may be made smaller.

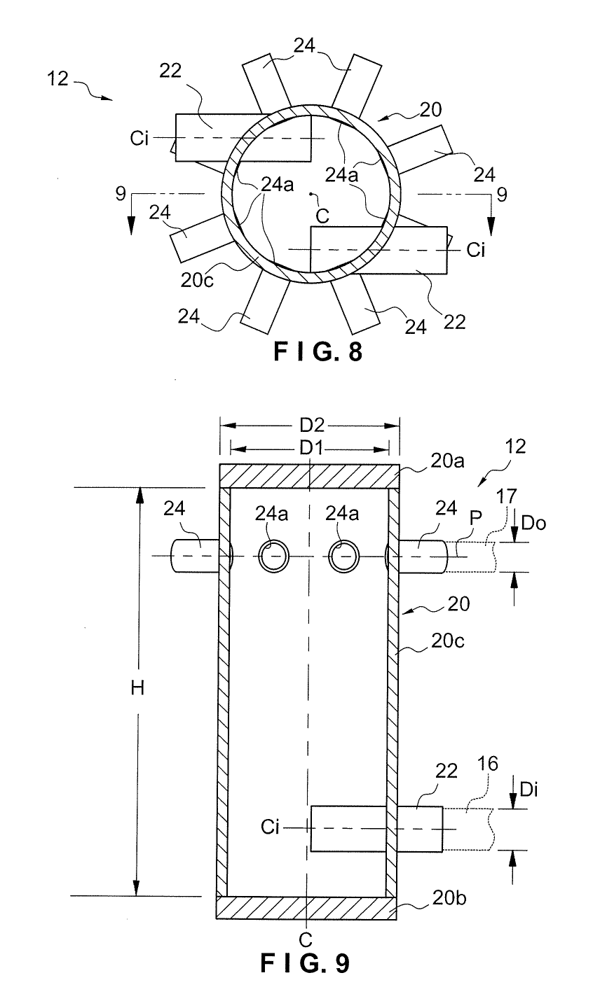

As shown in FIGS. 3 and 4, the inlet ports 22 are arranged with respect to the main body 20 so that the inlet ports 22 are disposed in a lower portion of the main body 20 in a state in which the center axis C of the main body is oriented in the generally vertical direction as shown in FIG. 2. Each of the inlet ports 22 has a cylindrical shape with a center axis Ci that penetrates into an inner space of the main body 20. The inlet ports 22 are arranged so that the center axes Ci are not parallel to and do not intersect with the center axis C of the main body 20 as shown in FIGS. 8 and 9. In other words, the inlet ports 22 are arranged with respect to the main body 20 so that the refrigerant flow entering into the main body 20 along the center axes Ci hits an inner wall of the main body 20, and generates an upward spiraling flow within the main body 20.

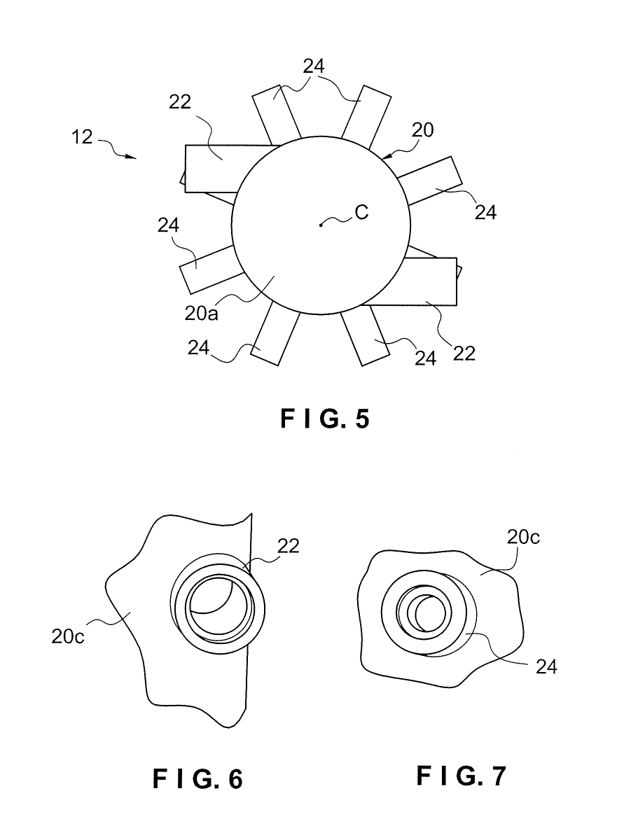

In the illustrated embodiment, the inlet ports 22 are disposed in a lower portion in the cylindrical part 20c of the main body 20 as shown in FIGS. 3 and 4. The inlet ports 22 are positioned so that the distance between the lower cover plate 20b and the inlet ports 22 in the direction of the center axis C of the main body 20 is set to be as small as possible while ensuring a sufficient space required for welding the inlet ports 22 and the lower cover plate 20b to the main body 20. In this embodiment, the center axis Ci of each of the inlet ports 22 extends in a direction generally perpendicular to the center axis C of the main body 20 as shown in FIG. 9. Moreover, in the illustrated embodiment, the inlet ports 22 are arranged generally symmetrically with respect to the center axis C of the main body 20 as shown in FIGS. 5 and 8. As shown in FIG. 6, an upstream end (external end) of each of the inlet ports 22 includes a counterbore section that is configured and arranged to be hermetically sealed with a corresponding one of the upstream pipes 16.

As shown in FIGS. 3 and 4, the outlet ports 24 are arranged in an upper portion of the main body 20 in the state in which the center axis C of the main body 20 is oriented in the generally vertical direction as shown in FIG. 2. As shown in FIGS. 8 and 9, the outlet ports 24 form a plurality of openings 24a that open to the inner space of the main body 20. All of the openings 24a are at least partially arranged in a plane P (FIG. 9) that is orthogonal to the center axis C of the main body 20. In the illustrated embodiment, the openings 24a of the outlet ports 24 are arranged generally symmetrically with respect to the center axis C of the main body 20 as shown in FIG. 8. As shown in FIG. 7, a downstream end (external end) of each of the outlet ports 24 includes a counterbore section that is configured and arranged to be hermetically sealed with a corresponding one of the connection pipes 17.

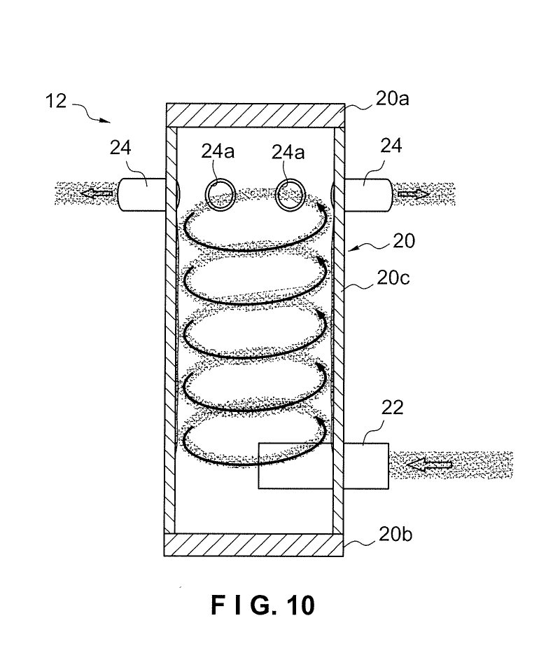

Referring now to FIG. 10, operation of the flow distributor 12 will be described. When the heat pump system 100 operates in heating mode, the two-phase refrigerant that passed through the internal passages 1a of the first heat exchanging part 1A enters the inlet ports 22 of the flow distributor 12 via the upstream pipes 16. Then, the two-phase refrigerant forms an upward spiraling flow (cyclonic flow) along an inner wall of the cylindrical part 20c of the main body 20, and guided toward the openings 24a of the outlet ports 24. Since the liquid component of the two-phase refrigerant has a higher density than the vapor component of the two-phase refrigerant, the liquid component of the two-phase refrigerant collects in an outer peripheral side of the spiraling flow due to the centrifugal force acting on the refrigerant and a liquid film having a generally uniform thickness is formed along the inner wall of the cylindrical part 20c as shown in FIG. 10. This process of generating the upward spiraling flow to collect the liquid component of the refrigerant toward the inner wall of the cylindrical part 20c of the main body 20 utilizes the same principle as cyclonic or vortex separation. The liquid component of the two-phase refrigerant is substantially evenly distributed as it travels upwardly and cyclonically along the inner wall of the cylindrical part 20c. The liquid component of the refrigerant is then sequentially discharged from the openings 24a of the outlet ports 24 formed in the cylindrical part 20c as the liquid component moves in cyclonic motion along the inner wall of the cylindrical part 20c. Therefore, the liquid component of the refrigerant is evenly distributed among the outlet ports 24.

With the flow distributor 12 of the present embodiment, even if an amount of the liquid component in the two-phase refrigerant flowing into the main body 20 from the inlet ports 22 fluctuates, since the liquid component is discharged from the openings 24a of the outlet ports 24 at a constant frequency due to cyclonic motion, time-averaged distribution of the liquid component can be made substantially uniform among the outlet ports 24.

Accordingly, with the flow distributor 12 of the present embodiment, the following two effects can be obtained by generating cyclonic flow of the two-phase refrigerant. First, the liquid component is uniformly distributed along the inner wall of the cylindrical part 20c (spatial-averaging). Second, the liquid component is evenly distributed among the outlet ports 24 over a given period of time (time-averaging). Moreover, since the refrigerant moves from a lower portion toward an upper portion within the main body 20, the vapor component of the refrigerant having a higher flow velocity and a lower density quickly moves toward the upper portion of the main body. On the other hand, the liquid component having a lower flow velocity and a higher density tends to collect in the lower portion of the main body 20. Therefore, stable liquid-vapor separation can be performed to obtain stable distribution of the liquid component to the outlet ports 24. Furthermore, with the flow distributor 12 of the present embodiment, flow condition (especially non-uniform distribution of the liquid component) of the refrigerant entering into the main body 20 through the inlet ports 22 can be canceled by subsequent cyclonic flow generated in the main body 20 as described above. Therefore, even when non-uniform flow condition of the liquid component in the refrigerant exists at the inlet ports 22 due to existence of a bent portion, a merged portion, and/or a diverging portion in the upstream pipes 16 connected to the inlet ports 22, distribution of the liquid component within the main body 20 is not largely affected by the non-uniform flow condition at the inlet ports 22. Moreover, even if the flow distributor 12 is arranged so that the center axis C of the main body 20 is slightly slanted with respect to the vertical direction, the liquid component in the two-phase refrigerant is evenly distributed into the outlet ports 24 due to generation of cyclonic flow within the main body 20.

Although the two-phase refrigerant that can be used with the flow distributor 12 of the illustrated embodiment is not limited to any particular refrigerant, it is preferable to use a two-phase refrigerant having a relatively small gas-liquid density ratio (ρG/ρL). More specifically, when a two-phase refrigerant having a relatively small gas-liquid density ratio is used as the two-phase refrigerant, the slip ratio (i.e., difference between flow velocities of the liquid component and the gas component) is relatively large because of a large difference between the density of the liquid component and the density of the vapor component. Therefore, when a two-phase refrigerant having a relatively small gas-liquid density ratio is used with the flow distributor 12 of the present embodiment, the liquid component and the vapor component of the two-phase refrigerant are smoothly separated and the liquid component is uniformly distributed along the inner wall of the cylindrical part 20c while the refrigerant moves along the upward cyclonic flow because the less-dense vapor component with higher velocity moves upwardly faster than the denser liquid component with lower velocity. Accordingly, the two-phase refrigerant is substantially uniformly distributed among the outlet ports 24. Examples of the two-phase refrigerant having a relatively small gas-liquid density ratio includes, but not limited to, propane, isobutane, R32, R134a, R407C, R410A and R404A. With the example of R134a, when the saturation temperature is 0° C., the vapor density (ρG) is about 14.43 kg/m³, the liquid density (ρL) is about 1295 kg/m³, and the density ratio or fraction (ρG/ρL) is about 0.011. With the example of R410A, when the saturation temperature is 0° C., the vapor density (ρG) is about 30.58 kg/m³, the liquid density (ρL) is about 1170 kg/m³, and the density ratio (ρG/ρL) is about 0.026. As used herein, the two-phase refrigerant having a relatively small gas-liquid density ratio preferably has a density ratio (ρG/ρL) that is smaller than 0.05 when the saturation temperature is 0° C.

Accordingly, the flow distributor 12 of the illustrated embodiment achieves highly efficient and uniform distribution of the two-phase refrigerant at low cost by the relatively simple structure as explained above. Also, design flexibility for the upstream component (e.g., the pipes 16) is improved because distribution of the liquid component in the two-phase refrigerant is not largely affected by the flow condition of the refrigerant at the inlet ports 22.

### Modified Embodiments

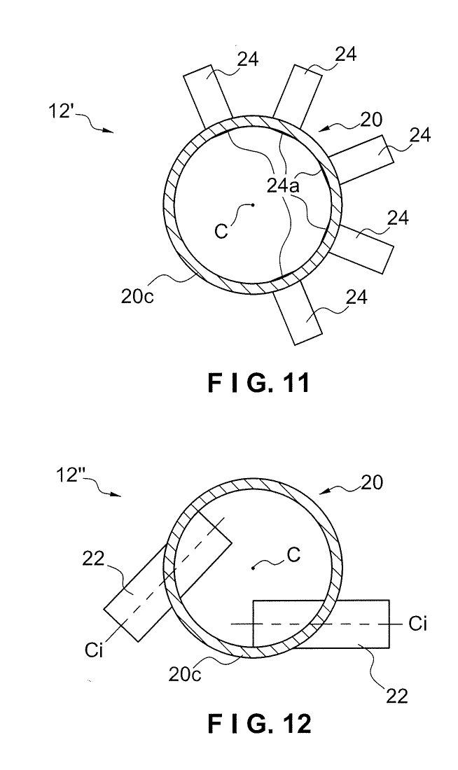

Referring now to FIGS. 11 to 14, several modified embodiments relating to the flow distributor will now be explained. In view of the similarity between the above-described embodiment illustrated in FIGS. 2 to 10 and the modified embodiments, the parts of the modified embodiment that are identical to the parts of the above-described embodiment will be given the same reference numerals as the parts of the above-described embodiment. Moreover, the descriptions of the parts of the modified embodiments that are identical to the parts of the above-described embodiment may be omitted for the sake of brevity. The parts of the modified embodiments that differ from the parts of the above-described embodiment will be indicated with a single prime (′), a double prime (″) or a triple prime (′″).

Although eight outlet ports 24 are provided in the above-described embodiment, the number of the outlet ports 24 is not limited to eight as long as the number of the outlet ports 24 is the same as or more than the number of the inlet ports 22. The number of the outlet ports 24 can be determined based on various considerations such as the number of the connection pipes 17, the number of the secondary flow distributors 14, the number of the internal passages 1b in the second heat exchanging part 1B, space limitation imposed on the flow distributor 12, etc.

Moreover, although, in the above-described embodiment, the outlet ports 24 are symmetrically arranged with respect to the center axis C of the main body 20 of the flow distributor 12, the outlet ports 24 may be arranged asymmetrically with respect to the center axis C of the main body 20 as shown in FIG. 11. Similarly to the embodiment illustrated in FIGS. 2 to 10, all of the openings 24a are at least partially arranged in the plane P (FIG. 9) that is orthogonal to the center axis C of the main body 20 in this modified embodiment. Therefore, the liquid component of the two-phase refrigerant can be evenly distributed among the outlet ports 24 due to generation of cyclonic flow of the refrigerant within the main body 20.

Although, in the above-described embodiment, the inlet ports 22 are symmetrically arranged with respect to the center axis C of the main body 20 of the flow distributor 12, the inlet ports 22 may be arranged asymmetrically with respect to the center axis C of the main body 20 as shown in FIG. 12. Since the flow condition of the refrigerant at the inlet ports 22 is canceled by generation of cyclonic flow within the main body 20, the liquid component can be distributed evenly even though the inlet ports 22 are not symmetrically arranged with respect to the center axis C of the main body 20. Thus, in this modified embodiment too, the liquid component of the refrigerant can be evenly distributed among the outlet ports 24 due to generation of cyclonic flow of the refrigerant within the main body 20.

The asymmetric arrangement of the outlet ports 24 as shown in FIG. 11 may be combined with the symmetric arrangement of the inlet ports 22 as in the above-described embodiment or with the asymmetric arrangement of the inlet ports 22 as shown in FIG. 12. Likewise, the asymmetric arrangement of the inlet ports 22 as shown in FIG. 12 may be combined with the symmetric arrangement of the outlet ports 24 as in the above-described embodiment or with the asymmetric arrangement of the outlet ports 24 as shown in FIG. 11.

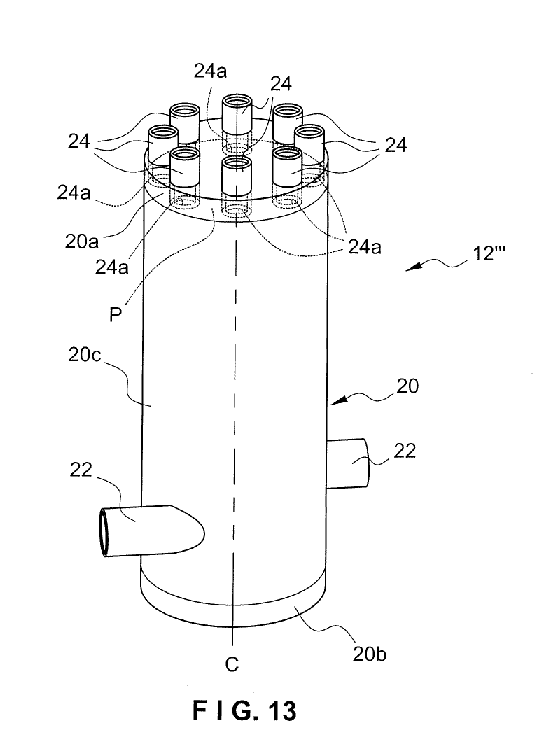

Although, in the above-described embodiments, the outlet ports 24 are formed in the cylindrical part 20c of the main body 20, the outlet ports 24 may be arranged in the upper cover plate 20a so that the openings 24a of the outlet ports 24 are disposed in the upper end wall of the main body 20 as shown in FIG. 13. In this modified embodiment, all of the openings 24a are entirely arranged on a plane formed by a bottom surface of the upper cover plate 20a, which is orthogonal to the center axis C of the main body 20. In this modified embodiment, the liquid component accumulated evenly on the inner wall of the cylindrical part 20c of the main body 20 is sucked into the high-velocity cyclonic flow of the vapor component in the refrigerant as the vapor component exits from the openings 24a formed on the upper end wall of the main body 20. Therefore, the liquid component of the refrigerant is evenly distributed into the outlet ports 24. Although FIG. 13 shows a symmetric arrangement of the outlet ports 24 with respect to the center axis C of the main body, it will be apparent to those skilled in the art from this disclosure that the outlet ports 24 need not be arranged symmetrically with respect to the center axis C.

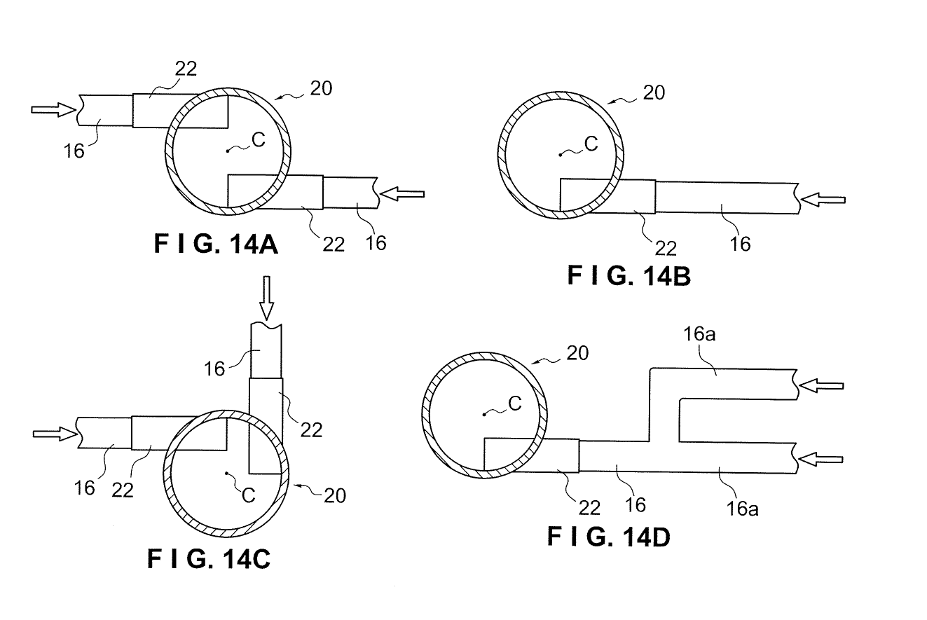

As shown in FIG. 14A, two inlet ports 22 that are connected to two upstream pipes 16 are provided in the flow distributor 12 of the above-described embodiment illustrated in FIGS. 2 to 10. However, the number of the inlet ports 22 is not limited to two. More specifically, the number of the inlet ports 22 can be determined based on various considerations such as the number of the internal passages 1a in the first heat exchanging part 1A, the number and arrangement of branching conduits of the upstream pipe 16, space limitation imposed on the flow distributor 12, etc. For example, only one inlet port 22 that is connected to one upstream pipe 16 may be provided in the main body 20 as shown in FIG. 14B. Alternatively, three or more inlet ports 22 that are respectively connected to three or more upstream pipes 16 may be provided. Moreover, depending on the arrangement of the upstream pipes 16, the inlet ports 22 may be provided asymmetrically as shown in FIG. 14C (and FIG. 12 as described above) to be suitably connected to the upstream pipes 16, thereby improving design flexibility of components disposed adjacent to the flow distributor. Moreover, the refrigerant path may include a plurality of branching pipe sections 16a merged into the upstream pipe 16 at a position upstream of the inlet port 22 as shown in FIG. 14D. Even when non-uniform flow condition of the liquid component in the refrigerant exists at the inlet port 22 due to existence of the merged portion in the upstream pipe 16 connected to the inlet port 22, such a non-uniform flow condition of the refrigerant entering into the main body 20 through the inlet port 22 is canceled by subsequent generation of cyclonic flow in the main body 20 as described above. Accordingly, the liquid component in the two-phase refrigerant is evenly distributed into the outlet ports 24 due to generation of cyclonic flow within the main body 20 regardless of the existence of a merged portion and/or a bent portion in the upstream pipe 16.

Although, in the illustrated embodiments, the reverse-cycle heat pump system 100 is used as an example of an environmental control system, the environmental control system of the present invention is not limited to the reverse-cycle heat pump system. More specifically, the environmental control system of the present invention can be any system that includes a heat exchanger for transferring heat between the refrigerant and the ambient air or substance (e.g., water), such as air-conditioning systems, HVAC systems, chillers, refrigerators, and the like. Moreover, although the flow distributing mechanism 10 is disposed between the first heat exchanging part 1A and the second heat exchanging part 1B that both function as evaporators, it will be apparent to those skilled in the art from this disclosure the flow distributing mechanism 10 may be disposed between two heat exchangers having separate functions, such as the evaporator and the condenser. In such a case, the flow distributing mechanism 10 is preferably disposed in an upstream portion of the evaporator so that the liquid component in the two-phase refrigerant can be evenly distributed into a plurality of flow passages in the evaporator.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A flow distributor adapted to distribute two-phase refrigerant into a plurality of flow paths, the flow distributor comprising:
a tubular main body having a center axis;
at least one inlet port disposed in a lower portion of the main body in a state in which the center axis of the main body is oriented in a generally vertical direction, the inlet port having a center axis that is not parallel to and does not intersect with the center axis of the main body so as to generate an upward spiraling flow of the refrigerant within the main body; and
a plurality of outlet ports forming a plurality of openings disposed in an upper portion of the main body in the state in which the center axis of the main body is oriented in the generally vertical direction, with all of the openings being at least partially arranged in a plane orthogonal to the center axis of the main body.

2. The flow distributor according to claim 1, wherein
the inlet port is disposed in a side wall of the main body.

3. The flow distributor according to claim 1, wherein
the center axis of the inlet port extends in a direction generally perpendicular to the center axis of the main body.

4. The flow distributor according to claim 1, wherein
an inner diameter D and an inner height H of the main body satisfy 2D<H<5D.

5. The flow distributor according to claim 1, wherein
the at least one inlet port includes a plurality of inlet ports with each of the inlet ports having a center axis that is not parallel to and does not intersect with the center axis of the main body.

6. The flow distributor according to claim 5, wherein
the inlet ports are arranged generally symmetrically with respect to the center axis of the main body.

7. The flow distributor according to claim 5, wherein
the inlet ports are arranged asymmetrically with respect to the center axis of the main body.

8. The flow distributor according to claim 1, wherein
the openings of the outlet ports are arranged generally symmetrically with respect to the center axis of the main body.

9. The flow distributor according to claim 1, wherein
the openings of the outlet ports are arranged asymmetrically with respect to the center axis of the main body.

10. The flow distributor according to claim 1, wherein
the openings of the outlet ports are disposed in a side wall of the main body.

11. The flow distributor according to claim 1, wherein
the openings of the outlet ports are disposed in an upper end wall of the main body.

12. An environmental control system comprising:
first and second heat exchanging parts; and
a flow distributing mechanism disposed in a refrigerant path between the first and second heat exchanging parts to distribute two-phase refrigerant flowing in at least one upstream pipe of the refrigerant path connected from the first heat exchanging part into a plurality of downstream pipes of the refrigerant path connected to the second heat exchanging part, the flow distributing mechanism including a flow distributor having
a tubular main body having a center axis oriented in a generally vertical direction,
at least one inlet port communicating with the upstream pipe, the inlet port being disposed in a lower portion of the main body and having a center axis that is not parallel to and does not intersect with the center axis of the main body so as to generate an upward spiraling flow of the refrigerant within the main body, and
a plurality of outlet ports communicating with the downstream pipes, the outlet ports forming a plurality of openings disposed in an upper portion of the main body with all of the openings being at least partially arranged in a plane orthogonal to the center axis of the main body.

13. The environmental control system according to claim 12, wherein
the flow distributing mechanism further includes a plurality of secondary flow distributors disposed between the outlet ports of the flow distributor and the downstream pipes to divide the refrigerant flowing from the outlet ports into a plurality of branching flows corresponding to the downstream pipes.

14. The environmental control system according to claim 12, wherein
the at least one upstream pipe of the refrigerant path includes a plurality of upstream pipes, and
the at least one inlet port of the flow distributor includes a plurality of inlet ports respectively connected to the upstream pipes with each of the inlet ports having a center axis that is not parallel to and does not intersect with the center axis of the main body.

15. The environmental control system according to claim 12, wherein
the refrigerant path includes a plurality of branching pipe sections merged into the upstream pipe at a position upstream of the inlet port of the flow distributor.

16. The environmental control system according to claim 12, wherein
the first heat exchanging part includes one or more refrigerant flow passages, and a second heat exchanging part includes a plurality of refrigerant flow passages, a number of the refrigerant flow passages in the first heat exchanging part being smaller than a number of the refrigerant flow passages in the second heat exchanging part.

17. The environmental control system according to claim 12, wherein
the first and second heat exchanging parts form a heat exchanging device configured and arranged to vaporize the refrigerant to exchange heat between the refrigerant and ambient air,
the first and second heat exchanging parts being arranged so that a dryness fraction of the refrigerant at an inlet portion of the first heat exchanging part being smaller than a dryness fraction of the refrigerant at an inlet portion of the second heat exchanging part.
